(19) United States
(12) Patent Application Publication
(10) Pub. No.: US 2022/0004589 A1
(43) Pub. Date: Jan. 6, 2022

(54) SERVICE PROVIDING APPARATUS AND METHOD FOR PROVIDING SEARCH INTENT

(71) Applicant: Ascent Korea Co., Ltd., Seoul (KR)

(72) Inventors: Seyong PARK, Seoul (KR); Jihoon KIM, Seoul (KR)

(73) Assignee: Ascent Korea Co., Ltd., Seoul (KR)

(21) Appl. No.: 17/243,167

(22) Filed: Apr. 28, 2021

(30) Foreign Application Priority Data
Jul. 3, 2020 (KR) 10-2020-0082068

(51) Int. Cl. G06F 16/953; G06N 20/00; G06F 40/289; G06F 40/30

(52) U.S. Cl. CPC G06F 16/953; G06F 40/30; G06F 40/289; G06N 20/00

(57) ABSTRACT

Provided are service providing apparatus and method for providing search intents, and more particularly, service providing apparatus and method for providing search intents to support to provide an accurate search intent for a query input from a user through a learning model by learning a correlation between a query and a search intent to a deep learning-based learning model. According to the present invention, it is possible to accurately determine and present the search intent of the input query by identifying a similar query having a predetermined level or higher of similarity with the input query through entity-based attribute comparison by applying the input query of the user who wants to understand the search intent to the completed learning model, and then calculating the search intent corresponding to the similar query having high similarity to the input query as the search intent of the input query.

### CROSS-REFERENCE TO RELATED APPLICATIONS

This application claims the priority of Korean Patent Application No. 10-2020-0082068 filed on Jul. 3, 2020, in the Korean Intellectual Property Office, the disclosure of which is incorporated herein by reference.

### BACKGROUND OF THE INVENTION

### Field of the Invention

The present invention relates to a service providing apparatus and method for providing a search intent, and more particularly, to a service providing apparatus and method for providing a search intent capable of supporting by learning a correlation between a query and a search intent to a deep learning-based learning model so as to provide an accurate search intent for the query input from a user through the learning model.

### Description of the Related Art

A search action is a destination-oriented action related to decision making (searching for necessary information, comparing prices, finding a desired place, finding a method to cope with a specific problem, etc.) and a means for directly expressing a user's intent related with goods (products) or services.

Currently, various search services supporting such a search action are provided, and the search service provides search results according to the search action through its own search engine.

However, in terms of marketing, search engines are important channels that support to enable search users who are looking for goods and services sold by companies to meet each other, but most search services are not provided with services beyond allowing keyword ads to be posted through search results generated by search engines.

In other words, the search query hides essential data required to establish a marketing strategy, and for example, even though the search query input when searching for products and services includes, as a search intent, data required for establishing the marketing strategy, such as users' needs for certain products and services, comparison items within a product line, awareness of specific brands and product names, types of information required before purchase, and needs to find a place to purchase in a specific region, there is no method for a general company other than a search provider to grasp and utilize the search intent from the search query.

The above-described technical configuration is the background art for assisting the understanding of the present invention, and does not mean a conventional technology widely known in the art to which the present invention belongs.

### SUMMARY OF THE INVENTION

An object of the present invention is to support to provide an accurate search intent for a query input from a user by learning a correlation between the query and the search intent in a deep learning-based learning model, and to establish a marketing strategy for a product or service based thereon.

According to an aspect of the present invention, there is provided a service providing method of a service providing apparatus for providing search intents, the service providing method including: an acquisition step of automatically generating one or more search queries in which a keyword and characters are combined while adding differently a series of characters to the keyword, and acquiring one or more associated queries associated with the search queries through a preset search engine; an entity generation step of applying the associated query to the search engine to extract one or more entities which coincide with words or phrases defined in an instance of pre-stored ontology information from predetermined top N search results among the generated search results and generating entity information including the extracted one or more entities and then generate an associated query corresponding the entity information and query information including the entity information; a learning step of generating learning data including the query information corresponding to the specific intent and the specific association query to learn the generated learning data in a predetermined learning model, when a plurality of intents and a plurality of queries, which are categories for search intent, are matched with each other and a specific intent matched to a query matching a specific related query in which the entity information is generated is extracted from the pre-stored intent DB; and a calculation step of generating query information for the input query by using the input query according to the user input as an association query in the entity generation step and then applying the generated query information to the learning model in which the learning is completed to calculate a final result including a correlation coefficient for each of the one or more intents corresponding to the input query through the learning model.

The learning step may further include a step of learning the learning model using a plurality of learning data obtained by performing the acquisition step, the entity generation step, and the learning step for each of a plurality of different keywords.

The association query may be an auto-complete search word generated by the search engine based on the search query.

The acquiring step may exclude an association query having a search volume of 0.

In addition, the ontology information may include entity definition information for each of a plurality of different entities corresponding to an object or concept, and the entity definition information may include a class corresponding to the category of the entity and an instance that is an entity name of the entity.

The entity generation step may be a step of setting one or more entities extracted in response to the association query as candidate entities and calculating the appearance frequency of each candidate entity for the top N search results to allow the only candidate entities of which appearance frequency is equal to or greater than the set reference value to be included in the entity information.

The search result may include one or more response results responded by determining the search intent for the association query by the search engine and one or more function types of the response function corresponding to the one or more response results and used by the search engine when calculating the response result, and the entity generation step may further include generating the query information so that one or more function types extracted from the search result generated in response to the association query and the entity information are set as attributes of the association query.

In the learning step, the correlation between the query and the intent may be set according to a change in entity information having a query as an attribute through learning of the learning model using the learning data.

The calculation step may further include generating and outputting a dashboard displayed to enable comparison between one or more intents calculated for the input query according to a correlation coefficient for each intent included in the final result based on the final result obtained.

According to another aspect of the present invention, there is provided a service providing apparatus including: a query generation unit configured to automatically generate one or more search queries in which a keyword and characters are combined while adding differently a series of characters to the keyword, and acquire one or more associated queries associated with the search queries through a preset search engine; an entity generation unit configured to apply the associated query to the search engine to extract one or more entities which coincide with words or phrases defined in an instance of pre-stored ontology information from predetermined top N search results among the generated search results and generate entity information including the extracted one or more entities and then generate an associated query corresponding the entity information and query information including the entity information; a learning unit configured to extract a specific intent matched to a query matching a specific association query in which the entity information is generated from a pre-stored intent DB by mutually matching a plurality of intents and a plurality of queries, which are categories for search intent, when the query information is received from the entity generation unit and generate learning data including the query information corresponding to the specific intent and the specific association query to learn the generated learning data in a predetermined learning model, when a plurality of intents and a plurality of queries, which are categories for search intent, are matched with each other and a specific intent matched to a query matching a specific related query in which the entity information is generated is extracted from the pre-stored intent DB; and a control unit of generating query information for the input query by using the input query according to the user input as an association query in the entity generation step and then applying the generated query information to the learning model in which the learning is completed for the plurality of different keywords to calculate a final result including a correlation coefficient for each of the one or more intents corresponding to the input query through the learning model.

According to the present invention, it is possible to automatically generate a plurality of queries using an automatic completion function of the search engine while adding characters based on the keyword, obtain a main word or phrase as an entity from the search result obtained through the search engine for each query to set the obtained entity as an attribute which is a feature of the query, and then learn the learning model with the most accurate search intent for the query to allow the correlation between the attributes of the query and the search intent with guaranteed reliability to be learned in the learning model. By automatically generating a plurality of queries and automatically securing the learning data necessary for learning the learning model, it is possible to ensure the ease of securing the learning data required for improving the reliability of the learning model. It is possible to accurately determine and present the search intent of the input query by identifying a similar query having a predetermined level or higher of similarity with the input query through entity-based attribute comparison by applying the input query of the user who wants to understand the search intent to the completed learning model, and then calculating the search intent corresponding to the similar query having high similarity to the input query as the search intent of the input query.

In addition, it is possible to apply a brand, a product, a service, etc. as an input query to the learning model, calculate a final result through the learning model, and score a correlation coefficient by one or more search intents having high relevance to the brand, the product or the service based on the final product to generate and provide a dashboard displayed to classify the importance of each search intent according to a score for each search intent. In addition, it is possible to provide a service provider to understand main search intents of users for a brand or product through the provision of the dashboard, and support a marketing strategy to be established by providing the main search intents to determine user's needs (consumer desires) such as what the user demands for a brand or product and why they are looking for.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a service providing apparatus for providing a search intent according to an embodiment of the present invention;

FIG. 2 is an exemplary diagram of information stored in an intent DB according to an embodiment of the present invention;

FIG. 3 is an exemplary diagram of an operation for a learning process of a service providing apparatus for providing a search intent according to an embodiment of the present invention;

FIG. 4 is an exemplary diagram for generating an association query by a service providing device according to an embodiment of the present invention;

FIG. 5 is an exemplary diagram for a search result used in the present invention;

FIG. 6 is an exemplary diagram for entity extraction of a service providing apparatus according to an embodiment of the present invention;

FIG. 7 is an exemplary diagram for generating learning data by a service providing apparatus according to an embodiment of the present invention;

FIG. 8 is an exemplary diagram for a feature of SERP;

FIG. 9 is an exemplary diagram of using a response result provided by a search engine of a service providing apparatus according to an embodiment of the present invention;

FIGS. 10 and 11 are operation exemplary diagrams of a process of calculating a final result related to a search intent by a service providing apparatus according to an embodiment of the present invention;

FIG. 12 is an exemplary diagram for providing a dashboard by a service providing apparatus according to an embodiment of the present invention; and

FIG. 13 is a flowchart of a service providing method of a service providing apparatus according to an embodiment of the present invention.

### DETAILED DESCRIPTION OF THE PREFERRED EMBODIMENT

Hereinafter, detailed embodiments of the present invention will be described with reference to the drawings.

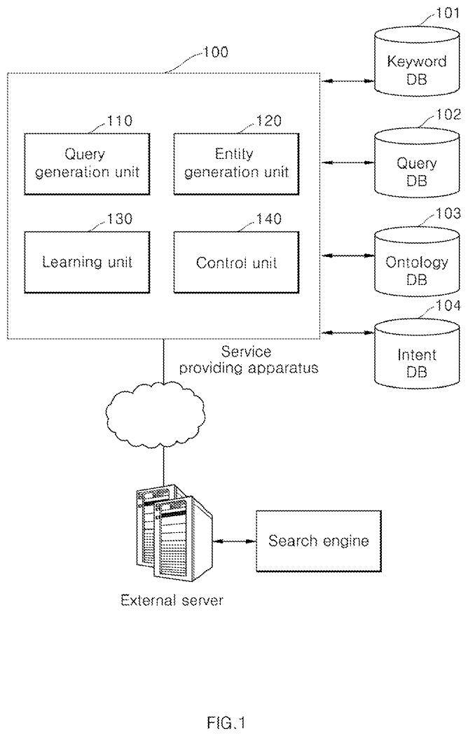

FIG. 1 is a block diagram of a service providing apparatus for providing a search intent according to an embodiment of the present invention.

As illustrated in FIG. 1, a service providing apparatus 100 according to the embodiment of the present invention includes a query generation unit 110, an entity generation unit 120, a learning unit 130, and a control unit 140.

In this case, the service providing apparatus 100 may be implemented by more constituent elements than the constituent elements illustrated in FIG. 1, or the service providing apparatus 100 may be implemented by fewer constituent elements.

In addition, at least one of the components constituting the service providing apparatus 100 may be included in the other component, and for example, the query generation unit 110, the entity generation unit 120 and the learning unit 130 may be included in the control unit 140.

In addition, the control unit 140 may execute an overall control function of the service providing apparatus 100 by using programs and data stored in advance . In addition, the control unit 140 may include a RAM, a ROM, a CPU, a GPU, and a bus, and the RAM, the ROM, the CPU, and the GPU may be connected to each other via a bus.

In addition, the service providing apparatus 100 includes a keyword DB 101 in which a plurality of different keywords are stored, a query DB 102 in which a plurality of different queries are stored, and an ontology DB 103 in which ontology information is stored, and an intent DB 104 in which a plurality of different intents, which are categories for a search intent are stored by matching parameters corresponding to each other among a plurality of queries.

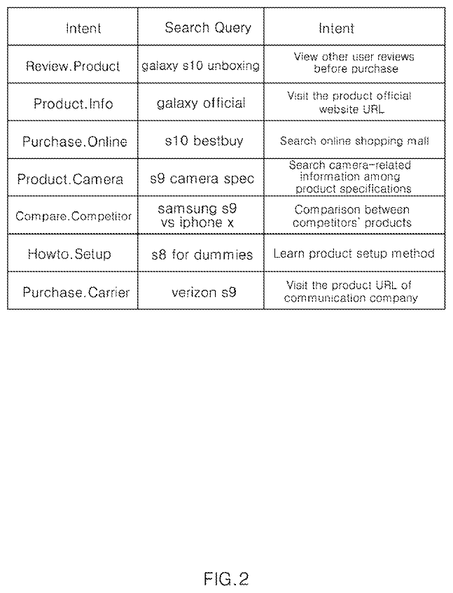

In this case, as illustrated in FIG. 2, the intent (intent information) matched and stored for each query in the intent DB 104 may be information on a predetermined search intent (question intent) for the query agreed by a plurality of users or a specific search intent (question intent) previously specified by a specific reviewer for the corresponding query.

In addition, the intent described in the present invention may mean any one of a plurality of different search intent-related categories predetermined by classifying a plurality of different search intents as a plurality of different categories (types), and the category may be the search intent itself.

For example, a first search intent for ‘product review’ and a second search intent for ‘acquisition of product information’ are classified as different categories, and the intent may be configured by data for either the first search intent or the second search intent.

Examples of using the keyword DB 101, the query DB 102, the ontology DB 103, and the intent DB 104 will be described in detail below, and the service providing apparatus 100 further includes a storage unit. The keyword DB 101, the query DB 102, the ontology DB 103, and the intent DB 104 may be stored in this storage unit.

In addition, the storage unit may store data and programs required for operating the control unit 140, and the control unit 140 may execute an overall control function of the service providing apparatus 100 by using the programs and data pre-stored in the storage unit.

In addition, the service providing apparatus 100 may be configured to further include a communication unit that communicates through a communication network, and the communication unit may communicate with a manager terminal of a manager who manages the service providing apparatus 100, a user terminal transmitting a query according to a user's input to the service providing apparatus 100, and various external servers via a communication network.

In this case, the service providing apparatus 100 may further include a user input unit for directly receiving an input from the manager or the user, and may receive the input of the manager or the user through the user input unit.

Further, the communication network described in the present invention may include various wired/wireless communication networks. Examples of the wireless communication network may include Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc. Further, examples of the wired communication network may include wired Local Area Network (LAN), wired Wide Area Network (WAN), Power Line Communication (PLC), USB communication, Ethernet, serial communication, optical/coaxial cables, etc.

Based on the above-described configuration, a detailed operation configuration of the service providing apparatus 100 will be described below with reference to the drawings.

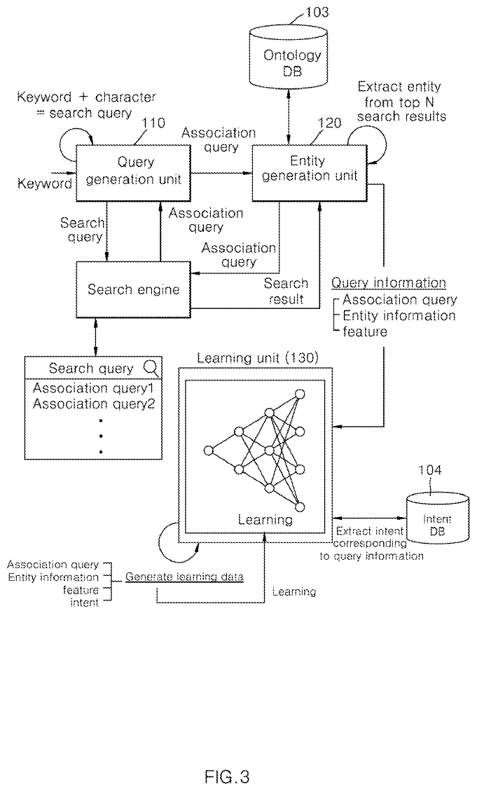

As illustrated in FIG. 3, first, the query generation unit 110 automatically generates one or more search queries in which keyword and characters are combined while adding a series of characters to the keyword differently, and acquire one or more associated queries associated with the search queries through a preset search engine.

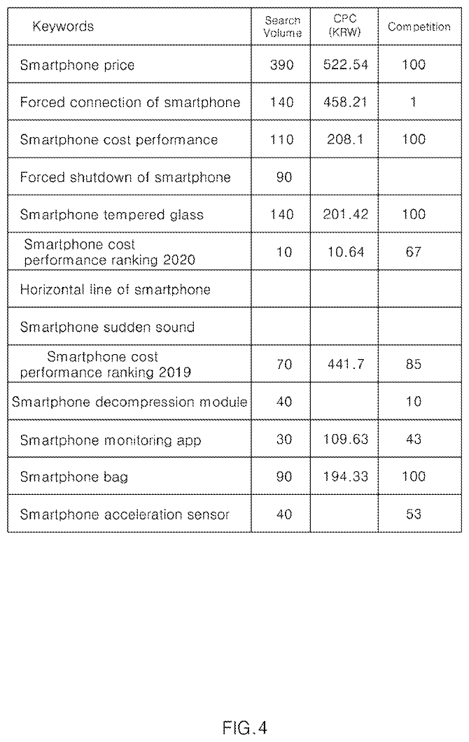

Referring to FIG. 4, the query generation unit 110 may extract a keyword ‘smartphone’ stored in the keyword DB 101, add ‘Ga’ to the keyword to generate a search query such as ‘smartphone Ga’, and add ‘Na’ to the keyword to generate a search query such as ‘smartphone Na’.

In addition, the query generation unit 110 may add characters from ‘Da’ to ‘Ha’ to the keyword ‘smartphone’ in sequence to generate search queries corresponding to each added character. Even in addition to the example, the query generation unit 110 may add a character with a final consonant such as ‘Gang’, add a foreign language such as ‘A’, or multiple characters such as ‘GaGa’, ‘price’, ‘AA’, ‘best’, etc. to the keyword.

In addition, characters that may be added to the keyword by the query generation unit 110 may include blank characters or special characters.

In addition, the query generation unit 110 may apply a search query ‘smartphone Ga’ generated as described above to a search engine preset in the service providing apparatus 100 or a search engine provided from an external server through communication with the external server to acquire an association query associated with ‘smartphone Ga’ from the search engine.

As an example of such a search engine, a search engine of ‘NAVER’ or ‘GOOGLE’ may be used. When the search engine is included in the service providing apparatus 100, the search engine-related execution data may be stored in the storage unit of the service providing apparatus 100.

In addition, the association query may be configured by an auto-complete search word (or an auto-complete query word) automatically completed a meaningful search word (or query word) by receiving the search query by the search engine.

For example, when the search engine receives the ‘smartphone Ga’ as a search query from the query generation unit 110, the search engine starts with ‘smart phone Ga’ or automatically generates an association query such as ‘smart phone price’, and ‘forced connection of smartphone’, which are auto-complete search words including the search query. The query generation unit 110 may acquire one or more associated queries for one search query from a search engine.

Alternatively, the search engine is included in an external server that provides (includes) the search engine based on the search query, and may search a DB in which the query is stored to acquire an association query starting with the search query or including the corresponding search query, and then provide the acquired association query to the query generation unit 110.

In addition, the search engine may add a series of characters to a search query or search the DB included in an external server that provides the search engine based on the search query and stored with the query to generate an association query as a sentence such as ‘which smartphone is most cost-effective?’ or extract the sentence included with the search query from the DB to provide the sentence to the query generation unit 110 as the association query.

In addition, the query generation unit 110 may store the association query acquired through the search engine in the query DB 102.

In addition, the query generation unit 110 may apply each of the one or more associated queries obtained from the search engine to the search engine to acquire a search result for each association query through the search engine.

In this case, the query generation unit 110 may check the search result to delete or exclude an association query in which nothing is searched, and may not store the deleted or excluded association query in the query DB 102. That is, the query generation unit 110 may exclude or delete an association query having a search volume of 0 without being stored in the query DB 102.

As an example, in the query generation unit 110, ‘smartphone horizontal line’ and ‘smartphone sudden sound’, which are associated queries obtained in response to a search query of ‘smartphone Ga’, have a search volume of 0 to be excluded without being stored in the query DB 102.

As described above, the query generation unit 110 may add a series of characters to a keyword to acquire one or more associated queries for each of a plurality of search queries generated differently from each other, and then store the acquired associated queries in the query DB 102.

Meanwhile, the entity generation unit 120 applies the association query stored in the query DB 102 to the search engine to extract one or more entities which coincide with words or phrases defined in an instance of pre-stored ontology information from predetermined top N search results among the generated search results and generates entity information including the extracted one or more entities and then generate an association query corresponding the entity information and query information including the entity information.

In this case, when the entity generation unit 120 interlocks with the query generation unit 110 and receives the association query acquired by the query generation unit 110 through the search engine from the query generation unit 110, the entity generation unit 120 applies an association query to the search engine instead of the query generation unit 110 to acquire a search result corresponding to the association query through the search engine. For the association query in which there is no search result, the association query may not be stored in the query DB 102 by controlling the query generation unit 110.

In addition, the query generation unit 110 maybe included in the entity generation unit 120.

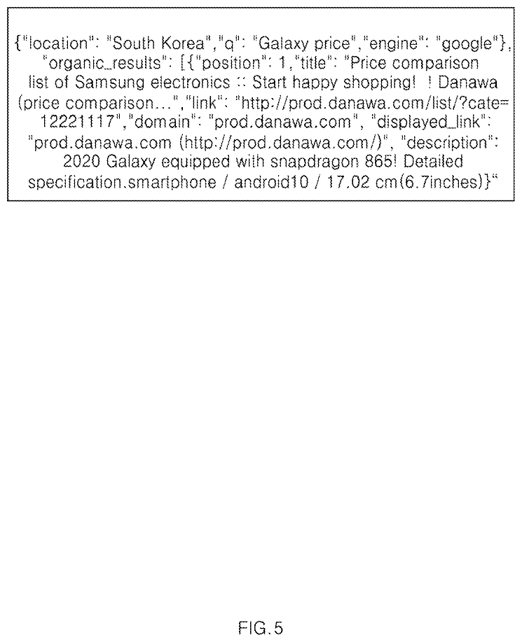

As an example described above, as illustrated in FIG. 5, each of search result information for each of one or more search results generated by the search engine includes a search language, a search region, a search engine name, a search result position (rank), a domain, a title, a text, etc., and may be configured as a text-based document.

Accordingly, the entity generation unit 120 checks the ranking of the search result from each of search result information for each search result calculated through the search engine in response to a specific association query to extract an entity from one or more entities included within a preset ranking according to the top N search results.

In this case, a preset ranking according to the top N search results maybe preset in the entity generation unit 120.

In addition, the ontology information includes entity definition information for a plurality of different entities corresponding to an object or concept, and the entity definition information may include a class corresponding to the category of the entity and an instance which is an entity name of the entity.

In general, ontology refers to a model that expresses what people see, hear, feel, and think about the world to be agreed through discussions between people in a conceptual and computer-controllable form.

In addition, classes and instances are constituent elements constituting ontology, and the classes are generally names given to things or concepts, and all things such as “keyboard”, “monitor”, and “love” may be called classes.

In addition, the instance may refer to itself appearing in a concrete object of an object or concept, or a practical form of an event and the like, and “LG Electronics ST-500 Ultra Slim Keyboard”, “Samsung Sync Master Wide LCD Monitor” and “Romeo and Juliet's Love” may be referred to as instances. Classification of the class and the instance may be very different depending on the application and purpose of use. In other words, an object with the same expression may be a class in some cases and then an instance in other cases.

In addition, the ontology information may refer to the ontology DB 103 itself.

In addition, the control unit 140 may collect the entity definition information from an external knowledge server that provides an online electronic dictionary, and store the collected entity definition information in the ontology information of the ontology DB 103. An example of such an external knowledge server may include a server that provides DBPEDIA or Wikipedia.

In addition, the control unit 140 may receive user definition information organized according to an ontology structure for a specific entity based on a user input through the user input unit configured in the service providing apparatus 100 to generate the entity definition information and then store the generated entity definition information included in the ontology information in the ontology DB 103.

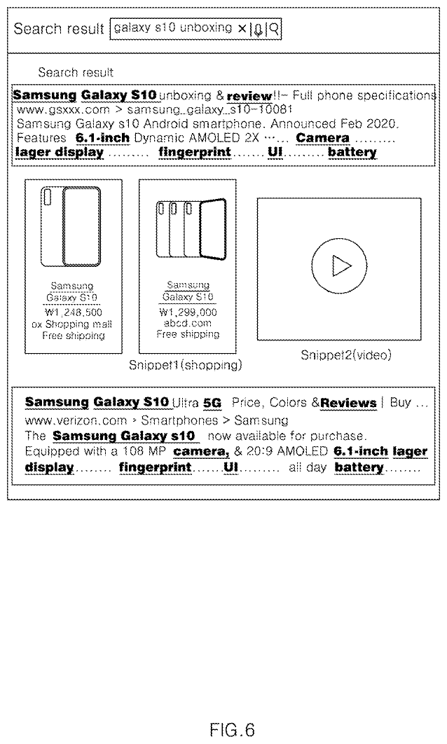

When describing the example described above with reference to FIG. 6, the entity generation unit 120 extracts ‘galaxy s10 unboxing’, which is an association query stored in the query DB 102, and then applies the association query to the search engine to obtain one or more search results.

In this case, the search engine may provide one web page including the one or more search results for the association query, and the search engine may include each of the one or more search results in a web page to be divided and distinguishable from each other within the web page.

Accordingly, the entity generation unit 120 may identify a text of each search result for the preset top N search results having a high association with the association query among one or more search results obtained by applying the association query to the search engine. The entity generation unit 120 may extract a text matching a word or phrase defined in an instance for each of a plurality of different entities for an object or concept included in the ontology information as an entity of the association query based on the ontology information pre-stored in the ontology DB 103.

As an example, the entity generation unit 120 may identify words or phrases that match the entity name included in the entity definition information of the ontology information such as ‘galaxy s10’, ‘Samsung’, ‘Review’, ‘UI’, ‘larger display’, ‘camera’, ‘battery’, ‘fingerprint’, ‘6.1-inch’, and ‘5G’ from the search result in response to the association query ‘galaxy s10 unboxing’ and extract the identified words or phrases as the entity in response to the association query ‘galaxy s10 unboxing’.

At this time, in the above-described entity extraction process, in the example, the search intent of the association query is for ‘galaxy s10’, which is a smartphone, and the entity extracted in response to the association query is also a phrase, such as ‘galaxy s10’, which is an example output accurately according to the search intent. However, there may be a case of being extracted together with ‘galaxy’ instead of ‘galaxy s10’, and the word may mean ‘eunha’ that is not related to the smartphone, so that an ambiguous language problem may also arise.

In order to solve this ambiguity problem, when the user grasps the search intent using the present invention for a specific purpose such as trend analysis of a product or service, the control unit 140 may receive and store setting information according to user input to limit the range of parameters specified in the class included in the object definition information when collecting entity definition information from an external knowledge server. Based on the setting information, the control unit 140 may collect only entity definition information associated with the company, product and service-related classes such as Person, Location, Place, Products, Organization, Company, Brand, etc., which are parameters of the class designated by the user.

Accordingly, the entity generation unit 120 may extract only entities associated with the company, product and service from the search result in response to the association query based on the ontology DB 103 in which only the entity definition information for which the company, product and service-related classes are set to prevent words or phrases that are not related to the smartphone from being extracted as an entity for an association query including “galaxy s10” which means a smartphone.

Alternatively, when the entity generation unit 120 extracts a plurality of individual entities using ‘galaxy’ and ‘s10’ for the association query ‘galaxy s10 unboxing’, in any one of the top N search results searched in response to the association query, the entity generation unit 120 may determine whether there is a case in which the individual entities ‘galaxy’ and ‘s10’ are consecutively arranged as ‘galaxy s10’. When the individual entities ‘galaxy’ and ‘s10’ are consecutively arranged, the entity generation unit 120 may generate context information for ‘galaxy s10’, which combines the individual entities ‘galaxy’ and ‘s10’ into one entity. For the context information, when a frequency of appearance is greater than or equal to a preset reference value by calculating the frequency of appearance from the top N search results, ‘galaxy’ and ‘s10’, which are a plurality of individual entities involved in the generation of the context information, are related to the association query to be determined to have a meaning as an entity when ‘galaxy s10’ is one entity, so that the plurality of individual entities may be replaced with one entity.

In this case, the entity may generate context information for the plurality of individual entities as described above only when the plurality of individual entities are continuously arranged in the search result, and determine the validity of the context information as an entity.

In addition, the entity generation unit 120 may generate entity information including one or more entities extracted from a search result corresponding to the association query in response to the association query.

In this case, the entity generation unit 120 sets one or more entities extracted in response to the association query as candidate entities, and calculates the appearance frequency of each candidate entity for the top N search results, so that the only candidate entities of which appearance frequency is equal to or greater than the set reference value may be included in the entity information as main entities.

As an example, the entity generation unit 120 may extract ‘galaxy s10’, ‘Samsung’, ‘Review’, ‘UI’, ‘larger display’, ‘camera’, ‘battery’, ‘fingerprint’, ‘6.1-inch’, ‘5G’ obtained for the association query ‘galaxy s10 unboxing’ as candidate entities, respectively, and generate entity information included only the main entities by setting the remaining candidate entities excluding ‘5G’ of which a frequency of appearance is less than the preset reference value as main entities of the association query.

In addition, in the above-described configuration, the entity generation unit 120 may extract main words or phrases from the candidate entities by using a simple and effective TextRank algorithm to extract the main words or phrases to select the extracted main words or phrases as main entities to be included in the entity information or calculate a point-wise mutual information (PMI) value between words to select a pair of words having a high value as a main entity as a group.

In the above-described configuration, the entity generation unit 120 may apply the association query to a search engine including a Bidirectional Encoder Representations from Transformer (BERT) model that analyzes the context of the query to generate the entity information for the top N search results obtained from the search engine.

In this case, the BERT model is a model applied to Google' s search engine for providing an accurate search result for the query by determining the search intent of the query, and an entity having high association to the search intent of the association query may be selected using the BERT model.

The entity included in the entity information obtained through the above-described method is determined as an attribute representing the characteristics of the association query.

In other words, in an image as an example, in order to identify an entity corresponding to an object included in the image through a learning model such as a deep-learning algorithm, feature points are extracted from the image and learned in the learning model as an attribute of the image, and when responding the image to the query, the entity may be used as the same role as the feature points of the image for the query.

In addition, when entity information is generated for the specific association query as described above, the entity generation unit 120 may generate entity information generated in response to the specific association query and query information including the specific association query.

In this case, the entity generation unit 120 may generate a plurality of different association queries corresponding to the plurality of different association queries through the above-described operation configuration for each of the plurality of different association queries stored in the query DB 102 and may store the plurality of query information in the query DB 102.

Meanwhile, the learning unit 130 may receive the query information from the entity generation unit 120 or extract the query information from the query DB 102.

In addition, the service providing apparatus 100 may include a pre-stored intent DB 104 by matching a plurality of different intents and a plurality of queries, which are categories for search intent, as described above. The learning unit 130 may determine whether a query coinciding with (matching) a specific association query included in the query information exists in the intent DB 104.

In this case, some of the plurality of different queries stored in the intent DB 104 may be matched to the same intent.

In addition, the learning unit 130 may extract a specific intent matched with a query matching a specific association query according to the query information from the intent DB 104.

Accordingly, when the specific intent matched to the query matching the specific association query in which the entity information is generated is extracted from the intent DB 104, the learning unit 130 may generate learning data including the specific intent extracted from the intent DB 104 and query information corresponding to the specific association query in response to the specific related query.

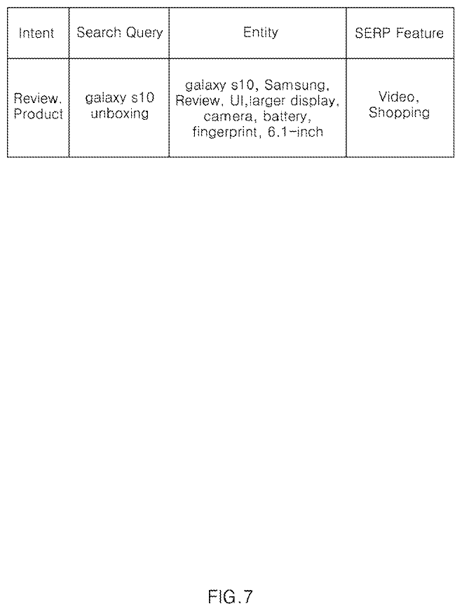

As an example, as illustrated in FIG. 7, the learning unit 130 matches a query coinciding with the specific association query with respect to the specific association query ‘galaxy s10 unboxing’ included in the query information, and extracts ‘Review.Product’, which is a data value for the search intent prestored in the intent DB 104 from the intent DB 104 as the specific intent which is the search intent of the specific association query. In addition, the learning unit 130 may generate entity information obtained in response to the specific association query and learning data including the specific association query and the specific intent as described above.

In addition, a learning model may be preset in the learning unit 130, and the learning model may be configured with a deep learning algorithm.

In this case, the deep learning algorithm may be constituted by one or more neural network models.

In addition, a neural network model (or neural network) described in the present invention may be consist of an input layer, one or more hidden layers, and an output layer, and the neural network model may applied with various types of neural networks, such as Deep Neural Network (DNN), Recurrent Neural Network (RNN), Convolutional Neural Network (CNN), Support Vector Machine (SVM), etc.

Accordingly, when the learning data is generated, the learning unit 130 may learn the corresponding learning data to the learning model, and generate a plurality of different learning data corresponding to each of a plurality of different query information as described above in response to each of the plurality of different query information stored in the query DB 102 to learn the generated learning data in the learning model.

Through the above-described configuration, the learning unit 130 may learn, in the learning model, a correlation between a query (association query) having an entity according to entity information as an attribute in the learning model and an intent that is a search intent.

That is, the learning unit 130 may learn the learning model so that the search intent is determined by the data value of the query itself and the attribute value according to the entity corresponding to the query, and may differently calculate the search intent between the plurality of queries when entities having a property of the plurality of queries are different from each other even if there is a large number of duplicated data between a plurality of queries and there is little difference in data values.

In other words, when searching for a specific query through a search engine, while the learning unit 130 determines main words or phrases that commonly appear in the top N search results with high accuracy for the search intent for a specific query as an attribute that accurately represents the characteristics of the search intent of the specific query, the learning unit 130 may match a predetermined search intent agreed by many users for the specific query and attributes determined for the specific search query to each other and learn the matched intent and attribute in the learning model. The learning unit 130 may learn a learning model on the correlation between the attributes of the query and the search intent given to the query, and may generate a learning model so that the learning model can accurately identify the search intent of the query by using the entity, which is an attribute of the query appearing in the search result obtained by applying the query to the search engine.

In addition, the learning unit 130 interlocks with the query generation unit 110 and the entity generation unit 120 through the control of the control unit 140 to perform the above-described process for a plurality of keywords stored in the keyword DB 101 and may generates one or more learning data for each of the plurality of keywords to generate a plurality of learning data and learn the learning data in the learning model whenever generating the learning data.

Through this, the learning unit 130 may allow the correlation between the query and the intent to be set in the learning model according to a change in entity information having a query as an attribute through learning of the learning model using the learning data.

Meanwhile, in the above-described configuration, the search engine determines the search intent of the association query in the search engine in addition to providing a document-based search result for a web site or web page for the association query received as an input to provide a direct response result as the search result by using a response function corresponding to the determined search intent among one or more different unique response functions provided by the search engine.

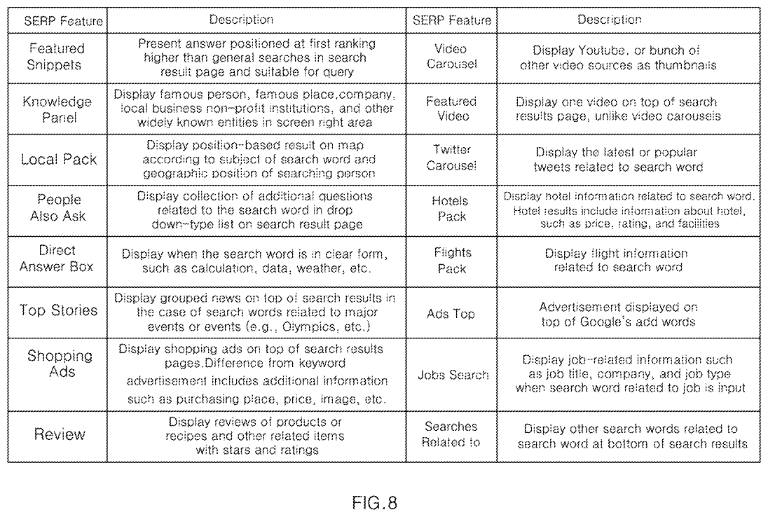

As an example, as illustrated in FIG. 8, a Google's search engine provides one or more search results through Search Engine Result Page (SERP), and determines the search intent of the query among the search results provided through SERP to generate and provide a response result according to a function feature corresponding to the search intent among a plurality of different response function-specific function types preset in the search engine, such as Snippets, Shopping Ads, Answer Box, Review, Featured Video, etc. in response to the search intent.

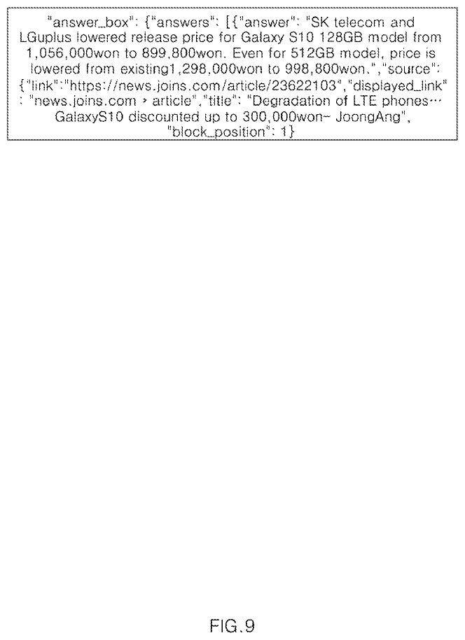

For example, as illustrated in FIG. 9, when the Google' s search engine receives a query for ‘galaxy s10 price’, determines a search intent of the corresponding query to determine that the search intent is related to an answer box, which is a response function that presents search results related to the answer, may generate a response result for the answer box that is one of a plurality of function types (response functions), and provide ‘answer_box’, an identifier of a function type (response function) corresponding to the response result to be included in the response result.

Accordingly, when at least one of the one or more search results calculated by the search engine in response to the association query is a response result generated by determining the search intent by the search engine, the entity generation unit 120 may extract a function type corresponding to the response result.

In this case, the extracted function type may mean an identifier for the function type.

In addition, the entity generation unit 120 may generate the query information so that one or more function types and the entity information extracted from the search result generated in response to the association query or extracted for each response result generated in response to the association query are set as an attribute of the association query.

As an example, as illustrated in FIG. 7, the query information includes ‘video’ and ‘shopping’, which are function types included in each of one or more response results calculated by the search engine fora specific association query ‘galaxy s10 unboxing’ as an attribute corresponding to the specific related query.

In addition, the learning unit 130 may generate learning data based on query information including the function type of the response function provided by the search engine and learn the generated learning data in the learning model.

That is, in the service providing apparatus 100, the search engine may determine the search intent for a specific association query to learn the function type of the response function used in response to the search intent in the learning model in association with a specific intent which is a search intent specified by user agreement for the specific related query. As a result, when the specific query indicates the specific search intent, entity information, which is an attribute of a required specific query, and a function type of the search engine may be set in the learning model.

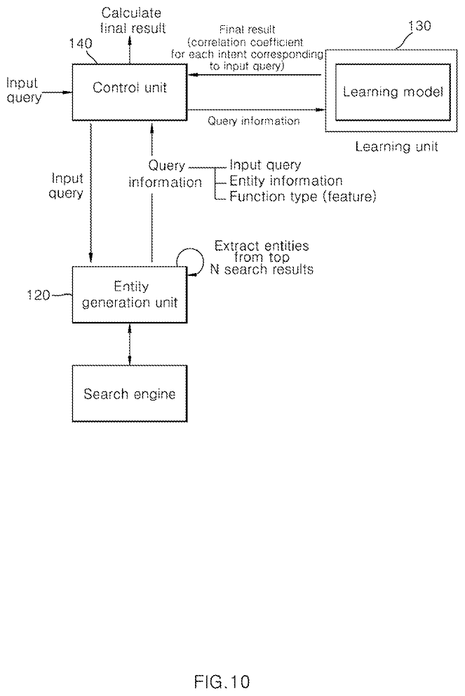

Through the above description, the service providing apparatus 100 learns, in a learning model, a correlation between the query attribute including the main entity obtained from the search result calculated by the search engine for the query and the response function used by the search engine by determining the search intent of the query, and the search intent corresponding to the query to calculate the attribute for any input query as described above. By applying to the learning model, the search intent corresponding to a query having an attribute similar to that of the input query through the learning model is calculated as the search intent of the input query to accurately calculate the search intent of the input query, and this will be described in detail with reference to FIG. 10.

As shown in the drawing, the control unit 140 of the service providing apparatus 100 may receive search intent request information including an input query according to a user input through a communication unit or a user input unit configured in the service providing apparatus 100.

In addition, when the search intent request information is received, the control unit 140 controls the entity generation unit 120 when receiving the search intent request information to apply the input query included in the search intent request information instead of the association query to the search engine through the entity generation unit 120. Like the configuration in which the entity is obtained in response to the association query through the entity generation unit 120, the control unit 140 may acquire the top N search results in response to the input query through the search engine, and then extract and obtain one or more entities corresponding to the input query from the top N search results.

In addition, after the control unit 140 may generate entity information including one or more entities obtained in response to the input query through the entity generation unit 120 and then generate entity information corresponding to the input query and query information including the input query in response to the input query.

At this time, the control unit 140 may extract one or more function types from the response result generated by the search engine in response to the input query through the entity generation unit 120, and then include the extracted one or more function types in the query information.

In addition, the control unit 140 may apply the query information for the input query to the learning model of the learning unit 130 on which the learning has been completed, and calculate a final result including at least one intent-specific correlation coefficient corresponding to the query information of the input query.

In this case, the final result may include one or more intents corresponding to the query information and a correlation coefficient for each of the one or more intents.

That is, the control unit 140 applies entity information including one or more entities generated in response to the input query to the learning model together with the input query as an attribute of the input query to identify one or more similar queries the input query in the learning model in order of higher similarity to the input query as an attribute when the input query has the entity information as an attribute in the learning model. One or more intents corresponding to each of the one or more similar queries may be included in the final result as search intents having high similarity to the input query, respectively. The similarity with the input query calculated in response to a specific similar query is calculated as a correlation coefficient that is a similarity between the specific intent corresponding to the specific similar query and the input query to be included in the final result.

In this case, the control unit 140 may calculate the final result by applying the function type together with the entity information as an attribute of the input query to the learning model.

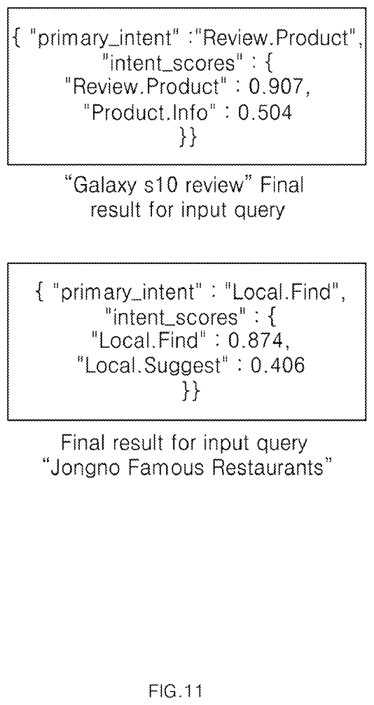

For example, as illustrated in FIG. 11, when ‘galaxy s10 review’ is received as an input query, the control unit 140 applies the entity information obtained as described above for the input query to the learning model together with the input query. The learning model calculates ‘Review.Product’, which is a search intent meaning a product review as a first intent corresponding to ‘galaxy s20 review’ which is a first similar query determined to have the highest similarity in order of attribute similarity through query comparison and attribute comparison based on the input query ‘galaxy s10 review’ and the entity information. After the first similarity query, the learning model may calculate ‘Product.Info’ meaning product details as a second intent corresponding to a second similar query ‘galaxy s10 official’ having a high similarity to the input query may be calculated through the learning model.

In addition, the control unit 140 may calculate first similarity, which is similarity between the input query and the first similar query to be the highest than other correlation coefficients as a first correlation coefficient between the first intent and the input query. The control unit 140 may calculate second similarity, which is similarity between the input query and the second similar query, as a second correlation coefficient lower than the first correlation coefficient as a correlation coefficient between the second intent and the input query. The first intent and the first correlation coefficient are matched and included in the final result, and the second intent and the second correlation coefficient are mutually matched to calculate the final result included in the final result.

In another example, when the control unit 140 receives the ‘Jongno famous restaurants’ as an input query, the control unit 140 may calculate ‘Local.Find’, which is a search intent to find restaurants in Jongno, Seoul obtained through the learning model, and ‘Local.Suggest’, which is a search intent to get recommendations for restaurants in Jongno, Seoul, based on ‘Jongno lunch’ or ‘Jongno restaurant recommendation’, which are similar queries with high similarity to the ‘Jongno famous restaurants’ as search intents corresponding to the input query and included in the final result, and calculate a correlation coefficient for each search intent included in the final result to calculate a final result included in the final result.

In the above-described configuration, the control unit 140 may exclude a search intent having a low relevance to the input query from the final result by including only the search intent having the correlation coefficient which is equal to or greater than a preset reference value in the final result.

Meanwhile, the control unit 140 may calculate a score for each search intent instead of the correlation coefficient by converting a correlation coefficient matched with each of the one or more search intents included in the final result into a score (score) using a Softmax function and include the calculated score in the final result.

In addition, the control unit 140 may set a search intent having the highest correlation coefficient or score among one or more search intents included in the final result as a main search intent in the final result in the final result as a main search intent to output the final result as the final result information through the output unit configured in the service providing apparatus 100 or a separate output device. Through this, the final result information may be provided so that the user may easily determine the main search intent of the input query and the search intent having high relevance to the input query based on the final result information.

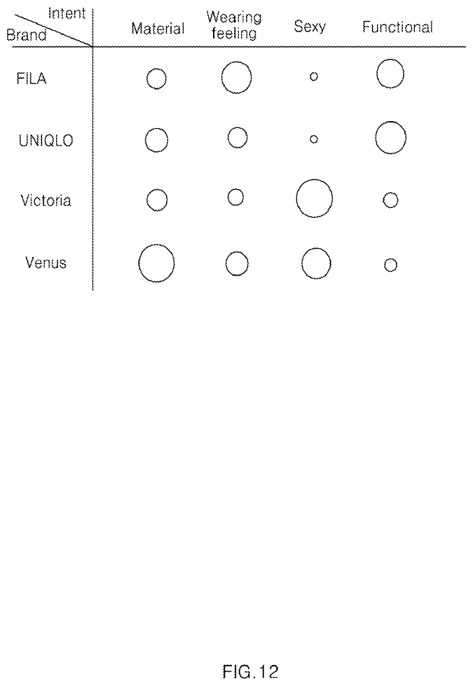

Based on the above-described configuration, as illustrated in FIG. 12, the control unit 140 receives a brand, a product name, a service name, etc. as an input query, and may generate and output a dashboard displayed to enable comparison between one or more intents calculated for the input query according to a correlation coefficient for each intent included in the final result based on the final result obtained by applying the query information for the input query to the learning model.

At this time, the control unit 140 receives a plurality of input queries to obtain a final result for each of the plurality of input queries through the learning model and then may generate a dashboard displayed to distinguish the size of the correlation coefficient among the plurality of input queries, the plurality of final results corresponding thereto, and one or more intents corresponding to the input query for each of the plurality of input queries based on the plurality of final results. Accordingly, a dashboard capable of comparing the size of the correlation coefficient for the same intent between the plurality of input queries may be generated and provided through the dashboard.

For example, the control unit 140 applies each of a plurality of different brands as an input query to the learning model and calculates the final result for each brand through the learning model to generate a dashboard displayed to classify the importance of each search intent for one or more search intents having high relevance to the brand for each of the plurality of brands according to the score according to the correlation coefficient based on the final result.

Through this, the service providing apparatus 100 according to the present invention may provide a service provider to understand main search intents of users for a brand or product through the provision of the dashboard, and provide the main search intents to determine user's needs (consumer desires) such as what the user demands for a brand or product and why they are looking for.

That is, the service providing apparatus 100 may provide analysis information for visually checking public's perception and response of the brand or product as a dashboard.

In addition, the service providing apparatus 100 according to the present invention may provide information on the characteristics of a product that needs improvement based on a search intent with a low score in the product through the provision of such dashboard-based analysis information. For example, in the case of an underwear brand, it is possible to provide a final result that has a high score of a search intent related to the wearing feeling, but a low search intent in a sexy sense to present the final result to a business provider of the corresponding brand to improve the product in such a sexy sense.

In addition, the service providing apparatus 100 according to the present invention may support the establishment of an effective advertising strategy or marketing strategy by analyzing the search intent of a brand or product through the provision of such dashboard-based analysis information.

As described above, according to the present invention, it is possible to automatically generate a plurality of queries using an automatic completion function of the search engine while adding characters based on the keyword, obtain a main word or phrase as an entity from the search result obtained through the search engine for each query to set the obtained entity as an attribute which is a feature of the query, and then learn the learning model with the most accurate search intent for the query to allow the correlation between the attributes of the query and the search intent with guaranteed reliability to be learned in the learning model. By automatically generating a plurality of queries and automatically securing the learning data necessary for learning the learning model, it is possible to ensure the ease of securing the learning data required for improving the reliability of the learning model. It is possible to accurately determine and present the search intent of the input query by identifying a similar query having a predetermined level or higher of similarity with the input query through entity-based attribute comparison by applying the input query of the user who wants to understand the search intent to the completed learning model, and then calculating the search intent corresponding to the similar query having high similarity to the input query as the search intent of the input query.

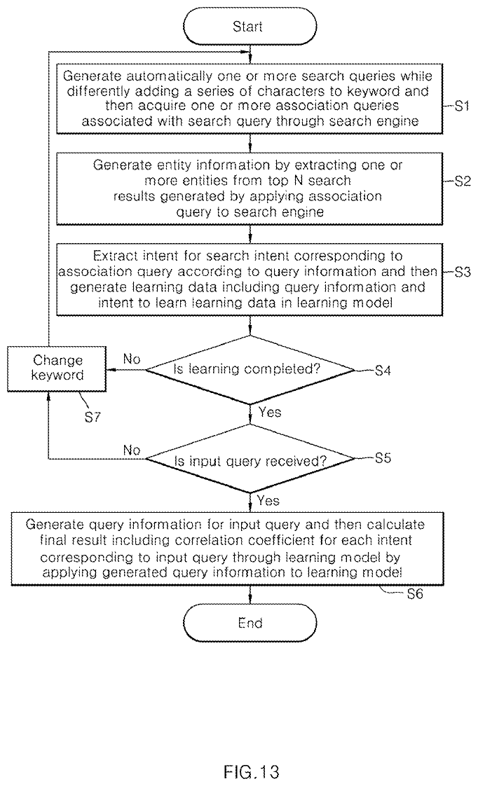

FIG. 13 is a flowchart of a service providing method for providing a search intent of the service providing apparatus 100 according to an embodiment of the present invention.

As illustrated in FIG. 13, the service providing apparatus 100 may perform a acquisition step (S1) of automatically generating one or more search queries in which a keyword and characters are combined while adding differently a series of characters to the keyword, and acquiring one or more associated queries associated with the search queries through a preset search engine.

Further, the service providing apparatus 100 may perform an entity generation step (S2) of applying the associated query to the search engine to extract one or more entities which coincide with words or phrases defined in an instance of pre-stored ontology information from predetermined top N search results among the generated search results and generating entity information including the extracted one or more entities and then generate an associated query corresponding the entity information and query information including the entity information.

Further, the service providing apparatus 100 may perform a learning step (S3) of generating learning data including the query information corresponding to the specific intent and the specific association query to learn the generated learning data in a predetermined learning model, when a plurality of intents and a plurality of queries, which are categories for search intent, are matched with each other and a specific intent matched to a query matching a specific related query in which the entity information is generated is extracted from the pre-stored intent DB 104.

In addition, when the service providing apparatus 100 receives the input query according to a user input (S5) while the learning model is learned (S4), the service providing apparatus 100 may perform a calculation step of generating query information for the input query by using the input query according to the user input as an association query in the entity generation step and then applying the generated query information to the learning model in which the learning is completed to calculate a final result including a correlation coefficient for each of the one or more intents corresponding to the input query through the learning model.

In this case, the service providing apparatus 100 may learn the learning model using a plurality of learning data obtained by performing the acquisition step, the entity generation step, and the learning step for each of a plurality of different keywords (S7).

Various apparatuses and components described in the present specification may be embodied by a hardware circuit (for example, a CMOS based logic circuit), firmware, software, or combinations thereof. For example, the apparatuses and components may be embodied by using a transistor, a logic gate, and an electronic circuit in the forms of various electric structures.

The aforementioned contents can be corrected and modified by those skilled in the art without departing from the essential characteristics of the present invention. Accordingly, the various embodiments disclosed in the present invention are not intended to limit the technical spirit but describe the present invention and the technical spirit of the present invention is not limited by the following embodiments. The protection scope of the present invention should be construed based on the following appended claims and it should be appreciated that the technical spirit included within the scope equivalent to the claims belongs to the present invention.

What is claimed is:

1. A service providing method of a service providing apparatus for providing search intents, the service providing method comprising:
an acquisition step of automatically generating one or more search queries in which a keyword and characters are combined while adding differently a series of characters to the keyword, and acquiring one or more associated queries associated with the search queries through a preset search engine;
an entity generation step of applying the associated query to the search engine to extract one or more entities which coincide with words or phrases defined in an instance of pre-stored ontology information from predetermined top N search results among the generated search results and generating entity information including the extracted one or more entities and then generate an associated query corresponding the entity information and query information including the entity information;
a learning step of generating learning data including the query information corresponding to the specific intent and the specific association query to learn the generated learning data in a predetermined learning model, when a plurality of intents and a plurality of queries, which are categories for search intent, are matched with each other and a specific intent matched to a query matching a specific related query in which the entity information is generated is extracted from the pre-stored intent DB; and
a calculation step of generating query information for the input query by using the input query according to the user input as an association query in the entity generation step and then applying the generated query information to the learning model in which the learning is completed to calculate a final result including a correlation coefficient for each of the one or more intents corresponding to the input query through the learning model.

2. The service providing method of claim 1, wherein the learning step further comprises a step of learning the learning model using a plurality of learning data obtained by performing the acquisition step, the entity generation step, and the learning step for each of a plurality of different keywords.

3. The service providing method of claim 1, wherein the association query is an auto-complete search word generated by the search engine based on the search query.

4. The service providing method of claim 1, wherein the acquiring step excludes an association query having a search volume of 0.

5. The service providing method of claim 1, wherein the ontology information includes entity definition information for each of a plurality of different entities corresponding to an object or concept, and the entity definition information includes a class corresponding to the category of the entity and an instance that is an entity name of the entity.

6. The service providing method of claim 1, wherein the entity generation step is a step of setting one or more entities extracted in response to the association query as candidate entities and calculating the appearance frequency of each candidate entity for the top N search results to allow the only candidate entities of which appearance frequency is equal to or greater than the set reference value to be included in the entity information.

7. The service providing method of claim 1, wherein the search result includes one or more response results responded by determining the search intent for the association query by the search engine and one or more function types of the response function corresponding to the one or more response results and used by the search engine when calculating the response result, and
the entity generation step further comprises generating the query information so that one or more function types extracted from the search result generated in response to the association query and the entity information are set as attributes of the association query.

8. The service providing method of claim 1, wherein in the learning step, the correlation between the query and the intent is set according to a change in entity information having a query as an attribute through learning of the learning model using the learning data.

9. The service providing method of claim 1, wherein the calculation step further comprises generating and outputting a dashboard displayed to enable comparison between one or more intents calculated for the input query according to a correlation coefficient for each intent included in the final result based on the final result obtained.

10. A service providing apparatus comprising:
a query generation unit configured to automatically generate one or more search queries in which a keyword and characters are combined while adding differently a series of characters to the keyword, and acquire one or more associated queries associated with the search queries through a preset search engine;
an entity generation unit configured to apply the associated query to the search engine to extract one or more entities which coincide with words or phrases defined in an instance of pre-stored ontology information from predetermined top N search results among the generated search results and generate entity information including the extracted one or more entities and then generate an associated query corresponding the entity information and query information including the entity information;
a learning unit configured to extract a specific intent matched to a query matching a specific association query in which the entity information is generated from a pre-stored intent DB by mutually matching a plurality of intents and a plurality of queries, which are categories for search intent, when the query information is received from the entity generation unit and generate learning data including the query information corresponding to the specific intent and the specific association query to learn the generated learning data in a predetermined learning model, when a plurality of intents and a plurality of queries, which are categories for search intent, are matched with each other and a specific intent matched to a query matching a specific related query in which the entity information is generated is extracted from the pre-stored intent DB; and
a control unit of generating query information for the input query by using the input query according to the user input as an association query in the entity generation step and then applying the generated query information to the learning model in which the learning is completed for the plurality of different keywords to calculate a final result including a correlation coefficient for each of the one or more intents corresponding to the input query through the learning model.
